(19) United States
(12) Patent Application Publication
(10) Pub. No.: US 2021/0364363 A1
(43) Pub. Date: Nov. 25, 2021

(54) TELESCANNING

(71) Applicant: PackThermo Technologies, LLC, Castle Pines, CO (US)

(72) Inventor: Craig Barragry, Castle Pines, CO (US)

(21) Appl. No.: 17/325,254

(22) Filed: May 20, 2021

Related U.S. Application Data
(60) Provisional application No. 63/028,027, filed on May 21, 2020.

(51) Int. Cl. G01K 1/024; G01K 1/14; G01B 11/02; G01B 11/00

(52) U.S. Cl. CPC G01K 1/024; G01B 11/005; G01B 11/026; G01K 1/146

(57) ABSTRACT

A system for property scanning includes a sensing pod, a temperature sensor provided to the sensing pod, a memory, one or more motors and a processing unit operatively coupled with the memory and the one or more motors. The temperature sensor is configured to measure a temperature of a remote object. The memory is configured to store data received from the temperature sensor. The one or more motors are configured to redirect the sensing pod. The processing unit is configured to control the one or more motors and process data from the temperature sensor. A method for property scanning includes, with a sensing pod, measuring a temperature of an object remote from the sensing pod and redirecting the sensing pod with one or more motors.

### CROSS REFERENCE TO RELATED APPLICATIONS

This application claims the priority benefit of U.S. Provisional Application No. 63/028,027 filed May 21, 2020, pending, which is incorporated herein by reference in its entirety.

### TECHNICAL FIELD

The disclosure pertains to measuring physical properties at a number of remote, disparate points.

### SUMMARY

The disclosure describes a telescanning system. The system includes a sensing pod, a temperature sensor provided to the sensing pod, a proximity sensor provided to the sensing pod, a memory, one or more motors and a processing unit operatively coupled with the memory, the one or more motors and the sensors. The temperature sensor is configured to measure a temperature of a remote object. The proximity sensor is configured to measure a distance of the remote object. The memory is configured to store data received from the temperature sensor and the proximity sensor. The one or more motors are configured to redirect the sensing pod. The processing unit is configured to control the one or more motors and to process data from the temperature sensor and the proximity sensor.

The disclosure also describes a system for property scanning. The system includes a sensing pod, a temperature sensor provided to the sensing pod, a memory, one or more motors and a processing unit operatively coupled with the memory, the one or more motors and the sensor. The temperature sensor is configured to measure a temperature of a remote object. The memory is configured to store data received from the temperature sensor. The one or more motors are configured to redirect the sensing pod. The processing unit is configured to control the one or more motors and process data from the temperature sensor.

Further, the disclosure describes a method for property scanning. The method includes, with a sensing pod, measuring a temperature of an object remote from the sensing pod and redirecting the sensing pod with one or more motors.

### BRIEF DESCRIPTION OF THE FIGURES

The summary above, as well as the following detailed description of illustrative embodiments, is better understood when read in conjunction with the appended drawings. For the purpose of illustrating the disclosure, example constructions of the disclosure are shown in the drawings. However, the disclosure is not limited to specific methods and instrumentalities disclosed herein. Moreover, those of ordinary skill the art will understand that the drawings are not to scale. Wherever possible, like elements have been indicated by identical numbers.

Embodiments of the disclosure will now be described, by way of example only, with reference to the following diagrams wherein:

FIG. 1 illustrates a schematic of an example embodiment of disclosed systems.

FIG. 2 illustrates a perspective view of an example scanning system.

FIG. 3 illustrates a top view of the example system of FIG. 2.

FIG. 4 illustrates a side view of the example system of FIGS. 2 & 3.

FIG. 5 illustrates an example flow of a method for property scanning.

FIG. 6 illustrates an example system performing a property scanning method.

### DETAILED DESCRIPTION

The following detailed description illustrates embodiments of the disclosure and manners by which they can be implemented. Although the preferred mode of carrying out the disclosure has been disclosed, those of ordinary skill in the art would recognize that other embodiments for carrying out or practicing the disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Embodiments of the disclosure substantially eliminate, or at least partially address, problems in the prior art, providing users with awareness of surroundings to ensure safety or identify dangerous situations.

Additional aspects, advantages, features and objects of the disclosure will be made apparent from the drawings and the detailed description of the illustrative embodiments construed in conjunction with the appended claims that follow. It will be appreciated that features of the disclosure are susceptible to being combined in various combinations without departing from the scope of the disclosure as defined by the appended claims.

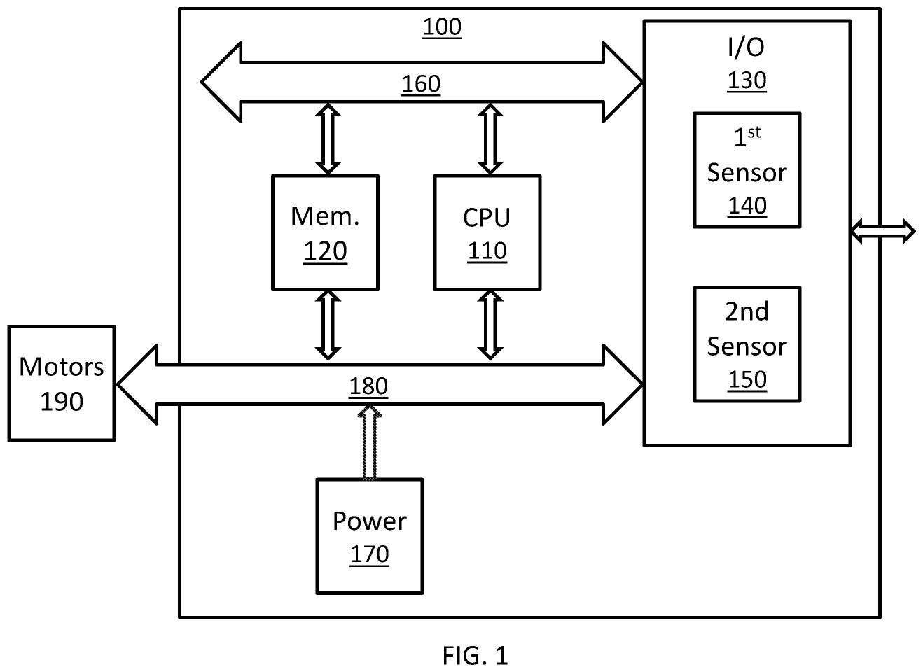

FIG. 1 schematically illustrates example relationships between example functional components of scanning system 100. System 100 may include, but is not limited to, a central processing unit, processing unit (CPU) or microprocessor 110, Input/Output (I/O) devices 130, a configuration of sensors 140 and 150 and one or more motors 190.

The system may further include a memory 120 and a system bus 160 that operatively couples various components including CPU 110, I/O devices 130, memory 120 and sensors 140 and 150. A power source 170 is provided to supply power to one or more of the components, for example, through power bus 180. Power source 170 may, for example, include a battery, a rechargeable battery or a 120V AC source. Referring to FIG. 1, sensors 140 and 150 are considered as part of the collection of I/O devices 130 but in other examples may be independent components and/or more directly coupled to system bus 160 and/or power bus 180.

Memory 120 optionally includes non-removable memory, removable memory, or a combination thereof. The non-removable memory, for example, includes Random-Access Memory (RAM), Read-Only Memory (ROM), flash memory, or a hard drive.

I/O devices 130 may include one or more speakers to provide audio output to a system user, one or more lights to provide visual output to a system user, a vibrating mechanism to provide palpable output to a user or a combination of these. I/O devices 130 enable output of notifications to a user. I/O devices 130 may include one or more devices operable to receive inputs corresponding to clicking, pointing, moving a pointer and/or pushing certain buttons on the keyboard. Additionally, I/O devices 130 may also include a microphone for receiving an audio input from the user.

Further, a display screen for presenting graphical images to a user of the system may be included. In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

First sensor 140 is configured to sense a first property and second sensor 150 is configured to sense a second property. Motors 190 are configured to redirect sensors 140 and 150.

Each of first sensor 140 and second sensor 150 may be or may otherwise include: an accelerometer, a magnetometer, a pressure sensor, a temperature sensor, a gyroscopic sensor, a Global Positioning System (GPS) sensor, a hygrometer, a timer, a proximity sensor, and a subatomic particle sensor. The sensors may be used to measure and collect data related surroundings of the system and associated physical properties. Additionally, outputs generated by the sensors may, for example, be indicative of temperature, velocity, acceleration, angular acceleration, location, orientation, proximity to objects, time, illumination, electrical fields, pressure, sound, force, chemistry, humidity, fluidity, scent, taste or a combination of these.

In some examples, processing unit 110 interfaces with sensors 140, 150, with I/O devices 130 and with motors 190 through software or programming having computer readable instructions stored to memory 120.

When executed on processing unit 110, the programming is configured to resolve and integrate outputs of the sensors into useful information about temperature, velocity, acceleration, angular acceleration, location, orientation, proximity to objects, time, illumination, electrical fields, pressure, sound, force, chemistry, humidity, fluidity, scent, taste or a combination of these.

Memory 120 may additionally include a non-transient data storage. The programming, when executed on processor 110, is optionally coupled to the storage and is configured to substantially continuously record and update sensor data in the storage.

The programming, when executed, is configured to cause processing unit 110 to interpret signals from first sensor 140 and second sensor 150 and output a notification to a user of system 100 in accordance with measured properties with consideration for any pre-programmed limits or thresholds. The programming may be further configured to cause processing unit 110 to output the notification through I/O devices 130 audibly, visually, palpably, tactily, haptically or a combination of these.

The programming may be further configured to cause processing unit 110 to change the position and/or orientation of sensors 140 and 150 with motors 190.

Furthermore, a network interface may be provided to allow the processing unit 110 to communicate with other data processing units, for example via a communication network, for purposes such as uploading sensor data, updating the software and/or downloading one or more new software associated with a property scanning service.

FIG. 1 is merely an example, which should not unduly limit the scope of the claims herein. It is to be understood that the specific designation for system 100 is provided as an example and is not to be construed as limiting the system to specific numbers, types, or arrangements of modules and/or components of the system. A person of ordinary skill in the art will recognize many variations, alternatives, and modifications of embodiments of the disclosure.

According to a method for producing a telescanning system, a first sensor configured to sense a first property of surroundings of the system is provided, a second sensor configured to sense a second property of the surroundings of the system is provided and the first sensor and the second sensor are communicatively coupled with a microprocessor configured to interpret signals from the first and second sensors to determine properties at one or more distances from the system and output a notification to a user of the system in accordance with the measured properties.

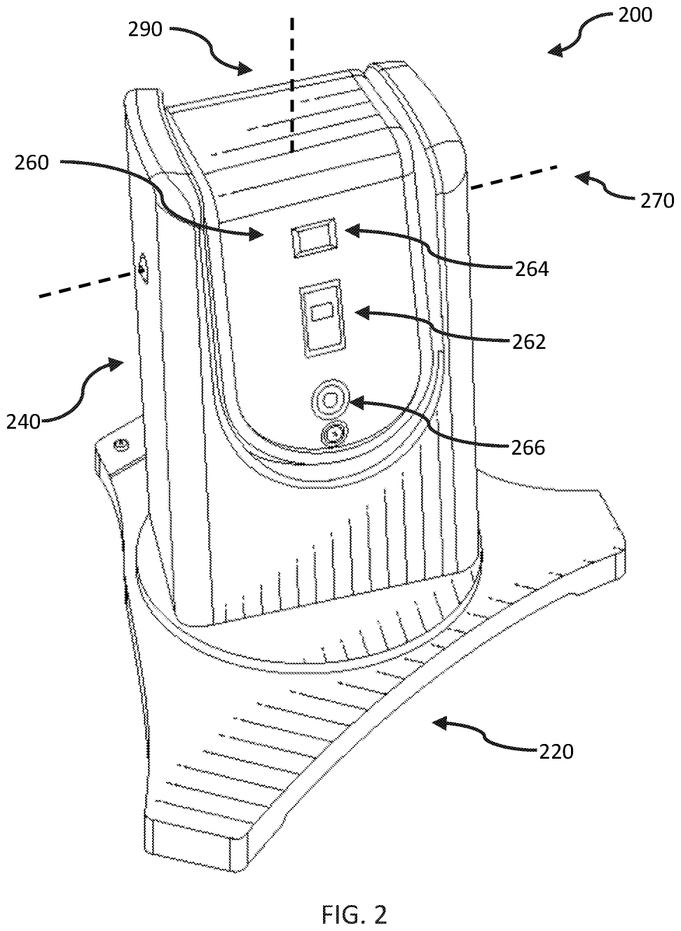

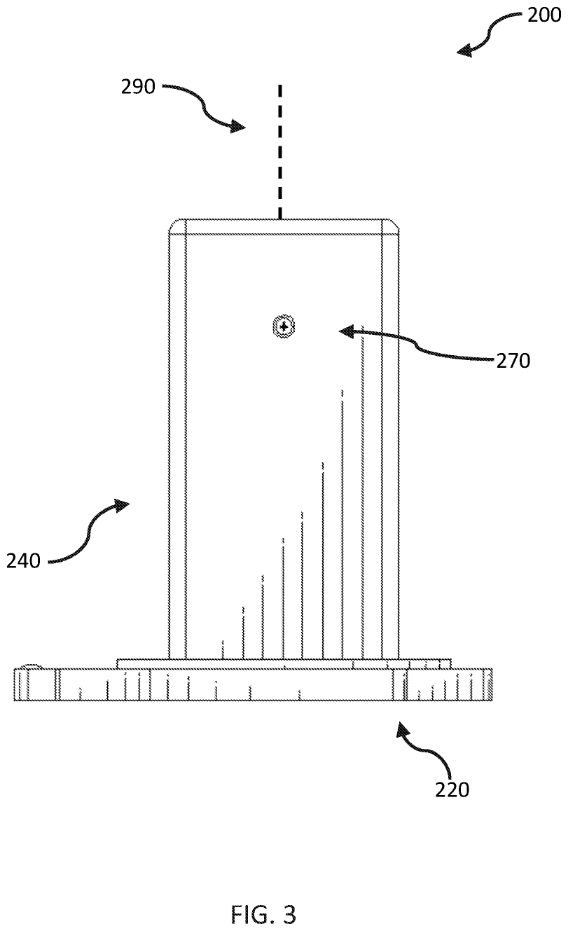

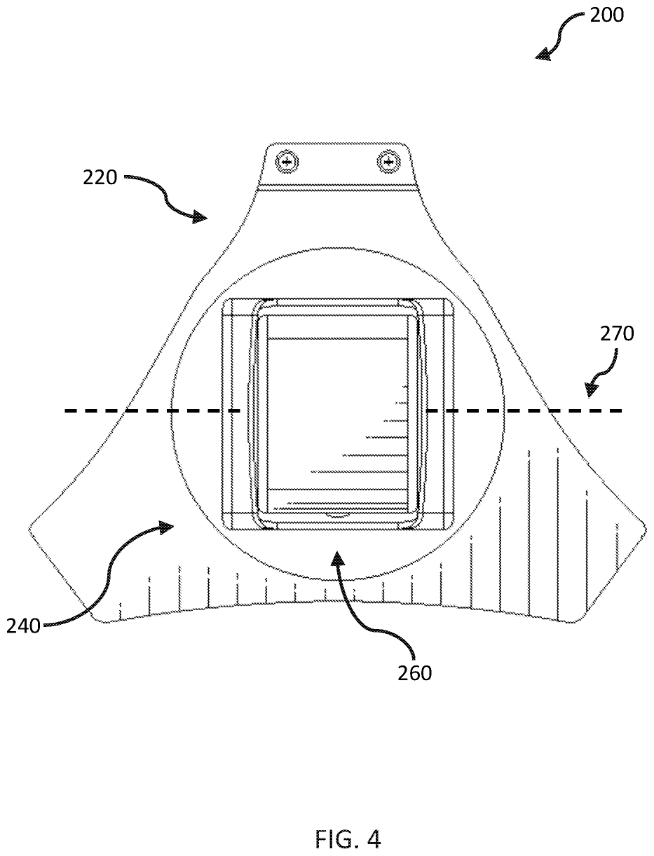

FIGS. 2-4 illustrate an example implementation of the system of FIG. 1. A system 200 has a sensing pod 260 pivotably supported by a pedestal 240 which is, in turn, rotatably supported by a base 220.

A temperature or thermal sensor 262 configured to measure a temperature of a remote object is provided to sensing pod 260. The system may further include, provided to sensing pod 260, a proximity sensor 264 configured to measure a distance to the remote object.

Temperature sensor 262 is configured to sense heat and/or temperature at a distance and/or without contact. In an example, temperature sensor 262 may project from an exterior surface of sensing pod 260. In a further example, temperature sensor 262 may be partially surrounded by a dome, a convex lens or a fisheye above the surface. In an example, temperature sensor 264 includes a thermistor, a thermocouple, an infrared sensor or a combination of these.

Proximity sensor 264 may be implemented with any of a variety of technologies in accordance with the intended applications of the system including but not limited to LIDAR, infrared, ultrasound, induction, capacitance and magnetism.

In an example, proximity sensor 264 may also project from an exterior surface of sensing pod 260. In a further example, proximity sensor 264 may similarly be partially surrounded by a dome, a convex lens or a fisheye above the surface. In another example, both sensors are partially contained within a single dome, lens or fisheye at a front of the mobile electronic device exterior housing.

A processing unit, a memory with which the processing unit is operatively coupled and I/O devices are provided to system 200 to interpret sensor data and control motors. The processing unit, memory and I/O devices of system 200 may be implemented as processing unit 110, memory 120 and I/O devices 130 and vice versa. The processing unit, memory and elements if I/O devices (not visible) may be housed within system 200 by sensing pod 260, by pedestal 240 or by base 220. Further, the processing unit and the memory may be provided on a single chip as part of a microcomputer.

The processing unit is further configured to determine the measured temperature is at or above a pre-established threshold, for example, by comparing the measured temperature to the threshold. The processing unit is further configured to process data from proximity sensor 264 and issue a notification reflecting the measured distance and/or the measured temperature. The notification may be issued in accordance with one or more I/O devices such as I/O devices 130. In an example, issuing the notification includes illuminating light emitting diode (LED) 266.

The processing unit may be further configured to compare temperature read to a pre-established temperature threshold and/or compare the distance sensed to a pre-established distance threshold and issue a notification reflecting the comparison.

In an example, the processing unit may be further configured to determine the measured temperature is at or above a pre-established threshold and the measured distance is at or below a pre-established threshold and issue a notification reflecting the measured temperature and the measured distance.

One or more motors such as motors 190 are provided to system 200 to redirect sensing pod 260. Sensing pod 260 may be supported by a shaft having spaced-apart first and second ends supported by pedestal 240. In an example, a motor provided to one or more of the first and second ends of the shaft is configured to rotate the shaft and, thereby, pivot sensing pod 260 to adjust the tilt angle of sensing pod 260 relative to pedestal 240 about a first axis 270. In another example, the shaft is fixed to pedestal 240 and sensing pod 260 rotates or pivots relative to the shaft about first axis 270. With base 220 supported on a horizontal surface, first axis 270 will be oriented generally horizontally as a result of being generally parallel with base 220 and/or a support surface upon which base 220 rests.

In being generally horizontally oriented, first axis 270 would appear to be horizontal to an ordinary observer and/or be within 1-2 degrees of horizontal. In being generally parallel with base 220, first axis 270 would appear to be parallel with base 220 to an ordinary observer and/or be within about 1-2 degrees of parallel.

Pedestal 240 may be supported by a first end of a shaft spaced-apart from a second end of the shaft mounted in base 220. In an example, a motor provided to the second end is configured to rotate the shaft and, thereby, rotate pedestal 240 relative to base 220 about a second axis 290 generally perpendicular with first axis 270. With base 220 supported on a horizontal surface, second axis 190 will be oriented generally vertically as a result of being generally perpendicular with base 220 and/or a support surface upon which base 220 rests. In another example, a motor provided to the first end is configured to rotate pedestal 240 relative to the shaft and, thereby, pedestal 240 relative to base 220 to which the second end of the shaft is fixed.

In being generally perpendicular with first axis 270, second axis 290 would appear to be perpendicular with first axis 270 to an ordinary observer and/or be within 1-2 degrees of perpendicular. In being generally vertically oriented, second axis 290 would appear to be vertically oriented to an ordinary observer and/or be within about 1-2 degrees of vertical.

The motors may be selectively energized by or otherwise controlled by the processing unit operatively coupled with the motors. In an example, one or more of the motors is a 9 g micro servo. The processing unit is further configured to interpret data from the temperature sensor with the sensing pod redirected and to interpret data from the proximity sensor with the sensing pod redirected.

The motors facilitate determining a more complete field of properties around the user and eliminate the need for individual sensors for each measurement point or location.

In an example, the system is 30 sq. in. or smaller and battery life is at least 12 hours. Further, the system may be capable of withstanding environmental conditions of between −50 and 150 degrees F. and constructured of sufficiently durable materials to remain intact and continue to function after experiencing a drop of 10 ft. or more. The system may further include one or more switches for turning the system on/off turning individual sensors on/off and/or turning the motors on/off. In an example, one or more RP8100 pushbutton switch may be used.

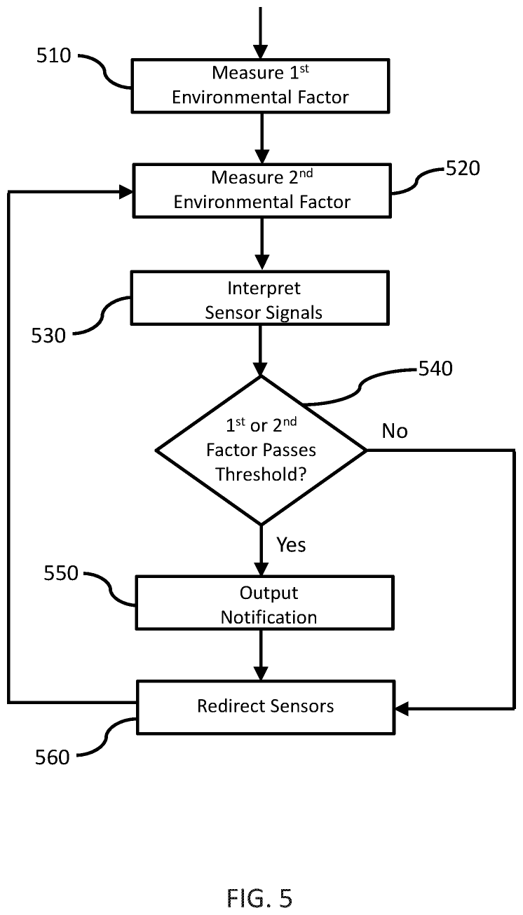

FIG. 5 illustrates actions of an example method for property scanning in accordance with an embodiment of the disclosure. The method is depicted as a collection of actions in a logical flow diagram which represents a sequence of actions that may be implemented with disclosed devices and systems.

A first property, for example temperature, is measured or sensed at 510. A second property, for example distance to one or more physical objects, is measured or sensed at 520. Sensors have a reading range of 10 ft. or more with +/−2% accuracy. Measured properties may be stored in a memory such as memory 120 for later use. In some implementations, the first and second properties are measured substantially simultaneously.

At 530, signals from the first and second sensors are interpreted to determine the property values. At 540, it is determined how the first and/or second property values relate to a threshold. For example, it may be determined whether a measured temperature meets or exceeds a temperature threshold and whether a measured distance is equal to or less than a distance threshold. In another example, it may be determined whether a measured temperature meets or exceeds a temperature threshold regardless of the distance measured. In yet another example, it may be determined whether a measured distance is equal to or less than a distance threshold regardless of the temperature measured.

A notification is then output to a user of the system at 550 in accordance with the threshold comparisons. Notifications may be withheld or otherwise not output to a user in accordance with some threshold comparisons. For example, when it is determined that a measured temperature is below a temperature threshold or a measured distance is above a distance threshold. Notifications may include sensor data, for example, in the form of values of the first and second measured properties. Notifications may take any of a variety of forms as suggested above with reference to I/O devices 130 (FIG. 1).

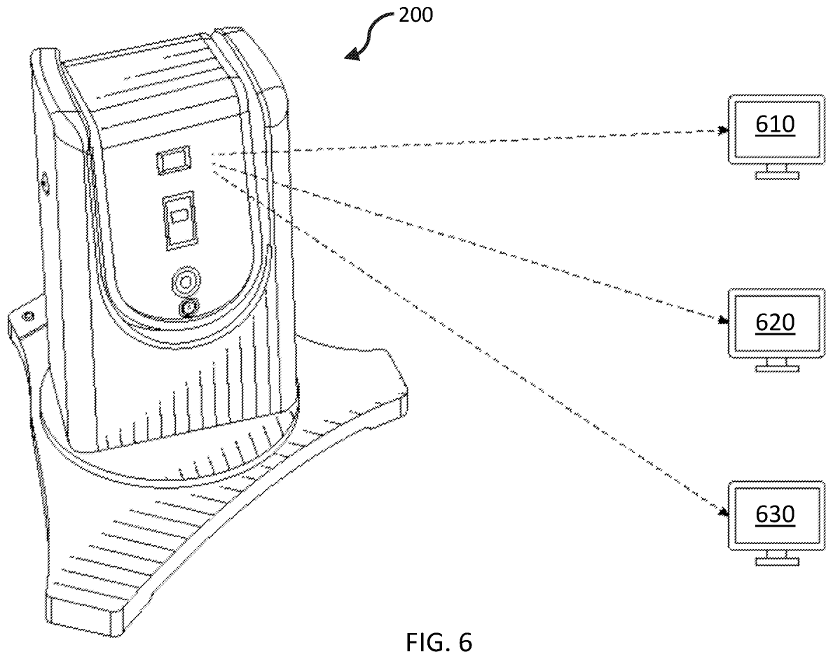

Redirecting the sensors at 560 by changing the position and/or orientation of the at least first and second sensors, the measuring the first and second properties is repeated at 510 and 520. FIG. 6 illustrates an example system performing a sensing method. After taking measurements at a first remote position 610, which may be a remote object or a point thereof, sensors are redirected to a second remote position/object 620 and measurements are taken again. The sensor may then be redirected again to a third remote position/object 630 where measurements may be taken again. This process can repeat for any desired number of iterations along any of a variety of scanning patterns depending on the positions/objects of interest. For example, the system may scan a row of three objects and then, after some interval, rescan the same row of three objects. In another example, the system may scan a multidimensional array. In an example, the system may scan along rows. In another example, the system may scan along columns.

As discussed above with reference to FIGS. 2-4, redirecting may be accomplished by adjusting a tilt angle of the sensing pod about a first axis and/or adjusting a rotation angle of the sensing pod about a second axis orthogonal to the first axis.

The actions described with reference to FIG. 5 are only illustrative and other alternatives can also be provided where one or more actions are added, one or more actions are removed, or one or more actions are provided in a different sequence without departing from the scope of the claims herein.

Embodiments of the disclosure also provide a computer program product that includes a non-transitory or non-transient computer-readable storage medium storing computer-executable code for property scanning. The code, which may include programming described with reference to FIG. 1, when executed, is configured to cause a processing unit such as 110, to perform actions of disclosed methods. As actions of the disclosed methods may be provided in different sequences, so the computer-executable code may be configured to provide a service having a different sequence of actions from those disclosed. In some examples, the code may be downloaded from a software application store, for example, from an “App store”, to a data processing unit.

Additionally or alternatively, the first sensor may include a plurality of sensors arranged in an array such as a two-dimensional array or a three-dimensional array. Similarly, the second sensor may include a plurality of sensors arranged in an array such as a two-dimensional array or a three-dimensional array. Such arrays facilitate determining a more complete field of properties around the user.

Embodiments of the disclosure are susceptible to being used for various purposes, including, though not limited to, enabling users to determine conditions of their surroundings.

Embodiments of the disclosure also provide for a mobile electronic device which may take the form of a wearable/hand-held device using sensor(s) in conjunction, reading properties within a radius around a user. Sensors report readings to a microprocessor programmed with specific limits/ranges. When conditions are met, microcontroller sends signal to a speaker, light, vibration element to alert user of the conditions.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

What is claimed is:

1. A telescanning system, comprising:
a sensing pod;
provided to the sensing pod, a temperature sensor configured to measure a temperature of a remote object;
provided to the sensing pod, a proximity sensor configured to measure a distance of the remote object;
a memory configured to store data received from the temperature sensor and the proximity sensor;
one or more motors configured to redirect the sensing pod; and
a processing unit operatively coupled with the memory, the one or more motors and the sensors, the processing unit being configured to control the one or more motors and to process data from the temperature sensor and the proximity sensor.

2. The system as set forth in claim 1, wherein the processing unit is further configured to:
determine the measured temperature is at or above a pre-established threshold and the measured distance is at or below a pre-established threshold; and
issue a notification reflecting the temperature measured and the measured distance.

3. The system as set forth in claim 1, wherein one of the motors is configured to adjust a tilt angle of the sensing pod about a first axis.

4. The system as set forth in claim 3, wherein one of the motors is configured to adjust a rotation angle of the sensing pod about a second axis orthogonal to the first axis.

5. A system for property scanning, comprising:
a sensing pod;
provided to the sensing pod, a temperature sensor configured to measure a temperature of a remote object;
a memory configured to store data received from the temperature sensor;
one or more motors configured to redirect the sensing pod; and
a processing unit operatively coupled with the memory, the one or more motors and the sensor, the processing unit configured to control the one or more motors and process data from the temperature sensor.

6. The system as set forth in claim 5, further comprising a proximity sensor configured to measure a distance to the remote object; and
wherein the processing unit is further configured to:
determine the measured temperature is at or above a pre-established threshold;
process data from the distance sensor; and
issue a notification reflecting the measured distance.

7. The system as set forth in claim 6, wherein the notification issued reflecting the measured distance also reflects the measured temperature.

8. The system as set forth in claim 5, wherein the processing unit is further configured to compare the measured temperature to a pre-established temperature threshold.

9. The system as set forth in claim 8, further comprising a proximity sensor configured to measure a distance to the remote object and wherein the processing unit is further configured to, based upon the comparison, issue a notification reflecting the measured distance.

10. The system as set forth in claim 5, wherein:
the processing unit is further configured to process data from the temperature sensor with the sensing pod redirected.

11. The system as set forth in claim 5, wherein one of the motors is configured to redirect the sensing pod about a first axis.

12. The system as set forth in claim 11, wherein one of the motors is configured to redirect the sensing pod about a second axis orthogonal to the first axis.

13. A method for property scanning, comprising:
with a sensing pod, measuring a temperature of an object remote from the sensing pod; and
redirecting the sensing pod with one or more motors.

14. The method as set forth in claim 13, further comprising:
determining the temperature measured is at or above a pre-established threshold;
measuring a distance of the remote object with the sensing pod; and
issuing a notification reflecting the measured distance.

15. The method as set forth in claim 14, wherein the notification issued reflecting the measured distance also reflects the measured temperature.

16. The method as set forth in claim 13, further comprising comparing the measured temperature to a pre-established temperature threshold.

17. The method as set forth in claim 16, further comprising, based upon the comparison, measuring a distance of the remote object with the sensing pod.

18. The method as set forth in claim 13, further comprising measuring a temperature of a remote object with the redirected sensing pod.

19. The method as set forth in claim 18, wherein redirecting further comprises adjusting a tilt angle of the sensor about a first axis.

20. The method as set forth in claim 19, wherein redirecting further comprises adjusting a rotation angle of the sensing pod about a second axis orthogonal to the first axis.
